(19) United States
(12) Patent Application Publication
(10) Pub. No.: US 2023/0140247 A1
(43) Pub. Date: May 4, 2023

(54) RANKING CRYPTOCURRENCIES AND/OR CRYPTOCURRENCY ADDRESSES

(71) Applicant: SRI International, Menlo Park, CA (US)

(72) Inventors: Karim Eldefrawy, Palo Alto, CA (US); Ashish Gehani, Atherton, CA (US); Alexandre Thomas Jean-Pierre Matton, San Francisco, CA (US)

(21) Appl. No.: 18/049,549

(22) Filed: Oct. 25, 2022

Related U.S. Application Data
(60) Provisional application No. 63/275,654, filed on Nov. 4, 2021.

(51) Int. Cl. G06Q 20/40

(52) U.S. Cl. CPC G06Q 20/401; G06Q 2220/00

(57) ABSTRACT

This disclosure describes techniques for ranking cryptocurrencies or cryptocurrency addresses. An example cryptocurrency ranking system includes memory and one or more processors, the one or more processors are configured to obtain blockchain including data indicative of a plurality of cryptocurrency transactions, open web data, and non-open web data. The one or more processors are configured to determine a multi-dimensional data structure for at least one cryptocurrency address based on the obtained blockchain data, the obtained open web data, and the obtained non-open web data. The one or more processors are configured to determine a reputation ranking for the at least one cryptocurrency address based on the determined multi-dimensional data structure and output the determined reputation ranking for the at least one cryptocurrency address.

This application claims the benefit of U.S. Provisional Application No. 63/275,654, filed Nov. 4, 2021, the entire contents of which is incorporated herein by reference.

### TECHNICAL FIELD

This disclosure generally relates to cryptocurrencies, more specifically, to ranking cryptocurrencies and/or cryptocurrency addresses.

### BACKGROUND

A cryptocurrency is a digital currency that may be exchanged through a computer network. Generally, cryptocurrencies have no central mint, support pseudonymous usage, and may distribute the effort of preventing double-spending. Cryptocurrencies may be used to purchase goods and services. However, the pseudonymous nature of cryptocurrencies may make them attractive for use by criminals. For example, some goods or services being offered for sale in exchange for cryptocurrencies may be illegal, such as counterfeit electronics, drugs, weapons, private data sets (personal information), or the like. Though mainstream use has grown rapidly, cryptocurrencies have also been used for nefarious activities. Several dark web marketplaces have been tracked down by the Federal Bureau of Investigation (FBI) and other law enforcement agencies.

Unlike ledgers maintained by traditional financial institutions, a cryptocurrency may use a blockchain ledger that is replicated on a peer-to-peer (P2P) network of computers spread geographically, such as throughout the world. This blockchain ledger may be accessible to anyone connected to the Internet via a cryptocurrency client or wallet software. A subset of nodes, called miners, in this P2P network may detect transaction requests from users, validate them, and then try to append them into the ledger as part of new blocks. Verifying a transaction entails two checks: (1) that the payer has previously received the cryptocurrency, and (2) that they have not already spent the cryptocurrency in another transaction. To limit the rate at which new blocks can be appended, miners must solve a cryptographic puzzle and provide a proof of work and/or a proof of stake that can be efficiently checked by other nodes. In exchange, miners receive freshly minted cryptocurrency when a block that they publish is accepted.

Some cryptocurrency blockchains can be accessed through web services designed to allow exploration of the respective ledgers. However, information about users is limited to their pseudonymous public key-based identities. The services generally do not provide any contextual information that would allow anonymous user reputations to be calculated. Conversely, public web search engines may not crawl the dark web and dark web search engines may not index cryptocurrency addresses.

### SUMMARY

In general, this disclosure describes cryptocurrency reputation (e.g., risk) ranking techniques for providing a ranking to the reputation of cryptocurrency addresses (e.g., wallet addresses) or a cryptocurrency as a whole. Like traditional currencies, these decentralized cryptocurrencies allow their users to remain pseudonymous. However, with traditional currencies, this benefit comes with a loss of accountability. In contrast, the public ledger of cryptocurrencies allows users to remain pseudonymous while allowing others to view the blockchain transaction(s). Such access to the blockchain may permit one to construct a reputation ranking for their pseudonyms.

The techniques of the disclosure may provide specific technical improvements to the computer-related field of cryptocurrency ranking that have practical applications. For example, the techniques set forth herein may enable a system to determine a risk level associated with a given cryptocurrency address. This risk level may be used by a user to determine whether or not to engage in a cryptocurrency transaction with the given cryptocurrency address. Additionally, the risk level may be used by institutions, such as law enforcement agencies, to prioritize investigations into potential criminal activity involving cryptocurrency. These techniques may also be used to determine a risk level associated with a given cryptocurrency.

In one example, this disclosure describes a cryptocurrency ranking system including a memory configured to store at least one cryptocurrency address; and one or more processors coupled to the memory, the one or more processors being configured to: obtain blockchain data, the blockchain data comprising data indicative of a plurality of cryptocurrency transactions; obtain open web data; obtain non-open web data; determine a multi-dimensional data structure for the at least one cryptocurrency address based on the obtained blockchain data, the obtained open web data, and the obtained non-open web data; determine a reputation ranking for the at least one cryptocurrency address based on the determined multi-dimensional data structure; and output the determined reputation ranking for the at least one cryptocurrency address.

In another example, this disclosure describes a method of ranking cryptocurrency including obtaining blockchain data, the blockchain data comprising data indicative of a plurality of cryptocurrency transactions; obtaining open web data; obtaining non-open web data; determining a multi-dimensional data structure for the at least one cryptocurrency address based on the obtained blockchain data, the obtained open web data, and the obtained non-open web data; determining a reputation ranking for the at least one cryptocurrency address based on the determined multi-dimensional data structure; and outputting the determined reputation ranking for the at least one cryptocurrency address.

In another example, this disclosure describes a non-transitory, computer-readable medium comprising instructions that, when executed, cause processing circuitry to: obtain blockchain data, the blockchain data comprising data indicative of a plurality of cryptocurrency transactions; obtain open web data; obtain non-open web data; determine a multi-dimensional data structure for at least one cryptocurrency address based on the obtained blockchain data, the obtained open web data, and the obtained non-open web data; determine a reputation ranking for the at least one cryptocurrency address based on the determined multi-dimensional data structure; and output the determined reputation ranking for the at least one cryptocurrency address.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example functional architecture of a cryptocurrency ranking system according to one or more aspects of this disclosure.

FIG. 2 is a chart illustrating an example where objects are cryptocurrency addresses according to one or more aspects of this disclosure.

FIG. 3 is a conceptual diagram illustrating an example reputation vector according to one or more aspects of this disclosure.

FIG. 4 is a block diagram illustrating example system for ranking cryptocurrencies according to one or more aspects of this disclosure.

FIG. 5 is a flow diagram illustrating example cryptocurrency address ranking techniques according to one or more aspects of this disclosure.

Like reference characters refer to like elements throughout the figures and description.

### DETAILED DESCRIPTION

As some cryptocurrency transactions may be fraudulent or illegal and may expose an unwitting participant in a transaction to some amount of risk, a system that facilitates a user in looking up a cryptocurrency address (e.g., wallet address) and receiving an analysis of the types of transactions, activities, and associations, in which the cryptocurrency address has been involved may enable more informed decision making when engaging in cryptocurrency transactions while also enabling legal authorities to more easily identify nefarious actors. Such a system may produce a user-friendly (e.g., easily readable) report summarizing such activities and may include a reputation/trustworthiness measure (e.g., a reputation or risk ranking) that captures trustworthiness and the type of associations (e.g., transactions and activities) such a cryptocurrency address had in the near and distant past. Such a system may allow users (which may also include entities, such as, financial entities, regulatory agencies, and/or law enforcement agencies) to determine whether transactions involving specific cryptocurrency addresses involved known or reputable entities (or not). Similarly, the system may also facilitate detection of whether the cryptocurrency address was involved in illegal activities, for example, on the dark web or on the open web (e.g., the “regular” Internet), such as scams using initial coin offerings (ICOs), or the like.

To associate a profile with each cryptocurrency address, a system may take a cryptocurrency address as an input and return a reputation report (which may include a risk ranking) for the cryptocurrency address. For example, the system may (i) extract cryptocurrency addresses and corresponding keyword contexts, concepts, persona data, or the like, from the open web data and non-open web pages; (ii) construct address neighborhoods using the payment, transaction, and block connectivity information; (iii) compute a reputation report for each input cryptocurrency address from a set of features extracted from the cryptocurrency address' context, neighborhood, and neighborhood's context; (iv) cluster related addresses together using intra- and inter-ledger time series analysis, for example, based on transfer entropy; and/or (v) provide access to the system through a web page, web service, browser plugin, mobile application, and/or any other way capable of accessing such information.

A system for ranking cryptocurrency may combine several data sources to build an explainable reputation report. Such data sources may include blockchain data (or other ledger data) associated with the cryptocurrency, dark-web data, open-web data (which may include social media data). Such a system may perform cross-ledger analysis to find synchronized activities across different ledgers. The system may also interactively engage with users (such as crowdsourcing labeling of transactions and addresses) and may incentivize users to participate by providing information in establishing the reputation system.

Such a system may provide a more comprehensive analysis of usage of cryptocurrencies based on data sources including more than just the public blockchain and transactions within the public blockchain, may provide a simple explainable reputation representation (e.g., a risk ranking), and may provide reasoning of how the reputation was determined.

Understanding how cryptocurrencies are affecting society depends on being able to analyze the context of their usage. However, the sheer scale of the ecosystem hinders analysis as the number of cryptocurrency transactions has grown dramatically.

A cryptocurrency ranking system, according to the techniques of this disclosure, may provide an increased confidence level in users in the legitimacy (or illegitimacy) of cryptocurrency address activities. The cryptocurrency ranking system may also provide for better compliance with Know Your Customer (KYC) and Anti Money Laundering (AML) rules and regulations. The system may provide for a defendable analysis of legitimacy uses of cryptocurrency, and increased transparency and awareness.

For example, social scientists may leverage the cryptocurrency ranking system to study the demographics of cryptocurrency users. Small businesses developing cryptocurrency applications can use the cryptocurrency ranking system to prototype mechanisms to comply with KYC regulations.

Legal scholars developing guidance for law enforcement can use the cryptocurrency ranking system to analyze the context of cryptocurrency use. Economists can utilize the cryptocurrency ranking system to perform studies of cryptocurrency user behavior.

The cryptocurrency ranking system of this disclosure may also provide a better understanding of the online uses of cryptocurrencies. The cryptocurrency ranking system of this disclosure may be used to apply pressure on and isolate users conducting illegal online activities (since their cryptocurrency addresses may be identified and be labeled as such). Such a system may be used to combat online (and offline) fraud involving cryptocurrencies.

As a motivating use case, the cryptocurrency ranking system may construct reputation reports of cryptocurrency wallet addresses. This may balance the privacy benefit of pseudonymous distributed cryptocurrencies with protections for end users. The cryptocurrency ranking system may provide a way to assess the credibility of counterparties in cryptocurrency transactions, help unsophisticated users make informed choices about potential transactions, and let third parties develop more refined fraud analytics.

In some examples, the techniques herein may be used to determine an overall ranking of reputation of a given cryptocurrency or compare any number of overall rankings of cryptocurrencies. For example, the system may combine all the data collected for a given cryptocurrency and determine an overall reputation or risk ranking for that cryptocurrency. For example, one cryptocurrency may be more frequently used for nefarious transactions than another cryptocurrency and may therefore have a lower reputation ranking than the other cryptocurrency.

The techniques disclosed herein should be understood not to be limited to private cryptocurrencies. These techniques may be used, for example, with a central bank digital currency, or any block chain-based cryptocurrency or other digital currency using a ledger system which is accessible by the public or which is private, but access has been granted to the system disclosed herein.

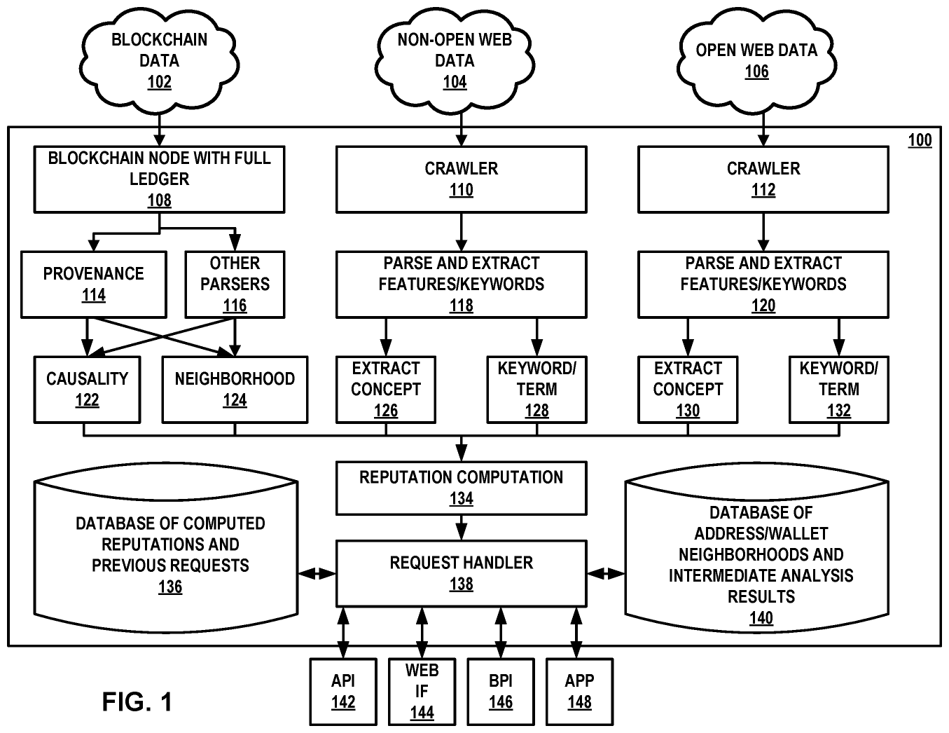

FIG. 1 is a block diagram illustrating an example functional architecture of a cryptocurrency ranking system according to one or more aspects of this disclosure. System 100 may collect data from different data sources, such as blockchain data 102, non-open web data 104, and/or open web data 106 (which may include social media data as users of social media sometimes post cryptocurrency addresses to the Internet via social media). Open web data 106 may include Internet data that is accessible by a standard web browser. Non-open web data 104 may include dark web data and/or private data. Dark web data may include Internet data that is accessible by a specialty web browser and/or a proxy. Private data may include data that is from a private data source, such as a law enforcement database, or the like. In some examples, access to a private data source may limited through passwords, credentials, and/or other access controls.

System 100 may analyze blockchain data 102, non-open web data 104, and/or open web data 106 to extract information relevant to understanding the history and associations of cryptocurrency addresses. System 100 may utilize the history and associations of the cryptocurrency addresses to construct cryptocurrency address or user (e.g., a user may be associated with more than one cryptocurrency address) reputations (which may include risk rankings).

After blockchain data 102, non-open web data 104, and open web data 106 is collected, system 100 may mine cryptocurrency address contexts that are suitable for computing user reputations. Such a context may consist of two components: (i) address or wallet, and transaction neighborhoods—that is, other addresses that are strongly associated with the cryptocurrency address being analyzed; and (ii) categories and concepts connected to the pages where the addresses were seen. System 100 may also extract concepts, keywords, and other data from non-open web data 104 and open web data 106. These techniques are discussed in further detail below.

In some examples, system 100 may also utilize other data sources. For example, system 100 may include a user interface (not shown in FIG. 1) which may include a touchscreen, a keyboard, a mouse, or other device for facilitating the manual input of data. This user interface may be used by law enforcement or other government agencies to manually enter additional data. In some examples, system 100 may include a network interface (not shown in FIG. 1) which may be used to connect system 100 with another cryptocurrency analysis system or service which may provide additional data to system 100 (e.g., the Internet).

System 100 may have a plurality of interfaces from which to request and receive cryptocurrency address reputation rankings through request handler 138. For example, system 100 may be reachable to a user via a web site (e.g., a web interface 144) and/or a smartphone application 148. The web site may provide a web interface 144 where a user may supply a cryptocurrency address and view the associated reputation summary and related analysis reports. Smartphone application 148 may provide the same functionality, but with a more user-friendly experience. For example, smartphone application 148 may support scanning a cryptocurrency address displayed as a QR code and automatically look up or determine the associated reputation or risk ranking.

Another interface may be a web browser plugin (BPI) 146, such as one similar to the Web of Trust (WOT) plugin. The WOT plugin provides ratings of web pages based on user input. While WOT relies on humans to provide ratings, web browser plugin 146 of system 100 may automatically scan a web page that a user is viewing, search for cryptocurrency addresses on the web page, and insert a link to an associated reputation for the user to click on should they be interested in knowing the associated reputation.

System 100 may also include a web-based application programming interface (API) 142 which may be configured to use by such people as cryptocurrency developers and programmers. API 142 may be implemented as a Representational State Transfer (REST) API. REST describes a standard approach for creating HTTP-based APIs, where four common actions—that is, view, create, edit, and delete—are mapped directly to HTTP methods—that is, GET, POST, PUT, and DELETE, respectively. API 142 may facilitate developers easily incorporating system 100's functionality into their web pages or applications. In some examples, system 100 may rate limit access to API 142 to manage resources and guard against denials-of-service attacks to bring system 100 down by automatically issuing request to compute/retrieve reputations of a large number of cryptocurrency addresses.

System 100 may include database 136 in which system 100 may store computed reputations and previous requests. For example, when system 100 determines a reputation, system 100 may store the determined reputation and any requests for such a reputation in database 136. In this manner, if another request is received by request handler 138, system 100 may provide the already computed reputation to the requestor via one of the interfaces or may use the already computed reputation as a starting point and update the already computer reputation prior to sending the update reputation to the requestor via request handler 138.

System 100 may also include database 140 in which system 100 may store address/wallet neighborhoods and any intermediate analysis reports. For example, when system 100 is processing blockchain data 102, non-open web data 104, and open web data 106, there may be several processing steps for which system 100 may store data in database 140.

Blockchain data acquisition and processing is now discussed. Blockchain data 102 may include the entire blockchain transaction history of considered cryptocurrency addresses, such as those cryptocurrency addresses for which system 100 is determining a ranking. For example, system 100 may download a blockchain node with the blockchain node's full ledger 108. For example, system 100 may employ a tool, such as Bitcoin full node (in the case where the cryptocurrency is Bitcoin) to download a transaction history for storage locally in memory of system 100.

System 100 may perform a provenance analysis 114, such as through using Statistical Packet Anomaly Detection Environments (SPADE) or BlockSci, on the blockchain ledger. System 100 may use other parsers 116 to parse the blockchain ledger to extract useful data, such as transactions, other cryptocurrency addresses, or the like. For example, system 100 may perform a provenance analysis 114 using provenance middleware, such as SPADE, to conduct and analyze wide range of provenance-based queries. For example, system 100 may discover all available paths (even through multiple intermediate transactions) between a payer and payee. System 100 may conduct an ancestral lineage query which may return all payers whose cryptocurrency goes to a specific transaction or payee. System 100 may conduct a query for descendants which may determine all payees who received all or part of a payment. System 100 may inspect an agent vertex (associated with a cryptocurrency address) which may allow all the incoming and outgoing payments to be directly identified.

System 100 may also perform a causality analysis 122 and a neighborhood analysis 124. A causality analysis may establish a cause and effect. Such an analysis may include determining a correlation, determining a sequence in time where the potential cause occurs before the potential effect, a plausible mechanism for the potential effect to flow from the potential cause, and eliminating the possibility of other causes.

In some examples, causality analysis 122 may include one or more algorithms using Transfer Entropy (TE) to determine the (abstract) amount of information transferred from one address to the other address to accurately capture causation. TE may measure the amount of directed transfer of information between two random processes (such as transactions between cryptocurrency addresses). TE from a process X to another process Y is the amount of uncertainty reduced in future values of Y by knowing the past values of X, given past values of Y. More specifically, of X, given past values of Y. More specifically, if Xₜ and Yₜ (where t∈N) denote two random processes and the amount of information is measured using Shannon entropy H(.), then TE can be framed: T_{X→Y}=H (Yₜ|Y_{t-1:t-L})−H(Yₜ|Y_{t-1:t-L}, X_{t-1:t-L}. Essentially, TE captures the conditional mutual information (I(.,.)) between two processes, with the history of the influenced process Y_{t-1:t-L} in the condition: TE_{X→Y}=I(Yₜ;X_{t-1:t-L}|Y_{t-1:t-L}).

System 100 may analyze dependencies of transactions to gain insight into which ones likely belong to the same entities. The same approach may also be used to identify sets of addresses that are likely to belong to entities that provide chains of services that depend on each other. For example, system 100 may: (1) set up a transaction time series (TTS), (2) combine and filtering the TTS, (3) conduct a pairwise TE computation, and (4) determine dependencies. For example, when cryptocurrency transactions are used to pay for (illicit) activities that involve multiple entities, then there are likely dependencies between the multiple entities.

System 100 may perform a neighborhood analysis 124. Neighborhood analysis 124 may include constructing a transaction graph “neighborhood” for each address using the corresponding cryptocurrency blockchain. Another type of analysis could assign keywords to addresses based on which websites upon which these addresses were found listed (e.g., via keyword and term analysis 128 and/or keyword and term analysis 132, discussed in more detail below). System 100 may assign topics and concepts can be assigned, using the text or other data found in open web data 106 and non-open web data 104. When a cryptocurrency address is found, system 100 may analyze the neighborhood of the particular cryptocurrency address, for example, beginning with cryptocurrency addresses whose payments have flowed to or from the particular cryptocurrency address (e.g., participated in a transaction with the particular cryptocurrency address in either a “buy” or “sell” direction). Cryptocurrency addresses involved in direct transactions with the particular cryptocurrency address may be considered to be a one hop from the particular cryptocurrency address as such cryptocurrency addresses are one transactional hop away from the particular cryptocurrency address. The neighborhood analysis 124 may further include analyzing additional cryptocurrency addresses participating in a transaction with one of the cryptocurrency addresses that participated in a transaction with the particular cryptocurrency address. Such additional cryptocurrency addresses may be considered to be two hops from the particular cryptocurrency address. In some examples, neighborhood analysis 124 may continue building a neighborhood of the particular cryptocurrency address by expanding to a number of hops beyond two. If system 100 queries the provenance of the particular cryptocurrency address, system 100 may determine a large graph of cryptocurrency addresses, payments, transactions, and blocks. However, only the subgraph of related addresses may be desired. Therefore, system 100 may abstract out the subgraph of related addresses, for example, using a sequential pattern discovery using equivalence classes (SPADE) algorithm.

In some examples, the size of a neighborhood may be limited to two hops from the cryptocurrency address for which the reputation is being determined. For example, a first cryptocurrency address for which the reputation is being determined may have a transaction with a second cryptocurrency address. This transaction between the first cryptocurrency address and the second cryptocurrency address may be considered one hop. The second cryptocurrency address may have a transaction with a third cryptocurrency address. This transaction between the second cryptocurrency address and the third cryptocurrency address may be considered another hop. As such, between the first cryptocurrency address and the third cryptocurrency address may, in this example, be two hops (assuming there was not also a transaction directly between the first cryptocurrency address and the third cryptocurrency address). In some examples, the number of hops included in a given neighborhood may depend on types of transactions or locations of transactions that have occurred. For example, if the first cryptocurrency address is involved in primarily dark web transactions, the number of hops included in the neighborhood of the first cryptocurrency address may be increased to a number greater than two.

System 100 may download a large corpus of non-open web data 104 using crawler 110. Crawler 110 may be specifically configured to crawl the dark web and/or private data sources, such as databases. For example, crawler 110 may include or utilize a specialty web browser and/or a proxy to crawl the dark web, as standard web browsers may not be able to access the dark web without a proxy. System 100 may collect non-open web data 104 in three stages: discovery, probing, and crawling. Dark web site names, also known as onion domains, may need to be discovered before data can be collected therefrom. System 100 may use various techniques to discover dark web site names. For example, system 100 may use previously published onion datasets, such as dark net market archives and/or onion address lists. System 100 may use an onion search engine, such as the Ahmia onion search engine, to generate a feed of onions discovered by the onion search engine. System 100 may also determine lists of onion domains by determining which onions were visited through Tor2web bridges 1. Additionally, public repositories of open web data may specify onion domains which system 100 may determine in open web data via crawler 112.

During probing, system 100 may determine which onion domains are currently reachable. For example, system 100 may employ an open source tool, such as a high speed probe (HSProbe) tool, to efficiently determine which onion domains are currently reachable. HSProbe uses Tor's Stem API to access onion sites, interpret a broad range of Tor Hidden Service protocol status messages, and determine how to proceed when HSProbe encounters errors or unresponsive sites. HSProbe also extracts new onion addresses from the top-level pages of the hidden services that HSProbe probes.

System 100 may include a crawling, extraction, and indexing tool to crawl onion sites which system 100 has determined to be active during the discovery and probing phases. While a generic dark web crawler suffices for most sites, certain onion domains may require customization. For example, access to some onion sites involves account registration or solving CAPTCHA puzzles or making a cryptocurrency transaction to enable deep crawling.

The content of web pages on which an address appears provides information which may be useful in computing or determining a reputation ranking. Therefore, system 100 may parse and extract features and/or keywords 118 from all the dark web pages found, for example, to extract specific data (such as titles, headers, cryptocurrency addresses, text, persona information, or the like). This information may be stored and indexed in memory of system 100 (e.g., in database 140). System 100 may automatically extract concepts 126 from the extracted features and/or keywords, for example, using a formal concept analysis (FCA). FCA is technique which may be used to derive a concept hierarchy from a collection of objects and their properties.

System 100 may also perform a keyword and term analysis 128. To perform keyword and term analysis 128, system 100 may, in some examples, use one or more machine learning algorithms. For example, system 100 may perform keyword and term analysis 128, including executing an audio to text conversion algorithm and/or a natural language processing algorithm, on audio data (including audio data within videos) of the captured dark web data (or other non-open web data), such as to identify audio containing cryptocurrency addresses or other keywords or terms of interest. For example, system 100 may execute a support vector machine. System 100 may execute a support vector machine (SVM) to cluster extracted keywords and terms into groups, such as those which indicate nefarious purposes and those which do not. System 100 may store the extracted concepts and keyword and term analysis in database 140 and/or may invoke reputation computation 134 as discussed below to use the extracted concepts and keyword and term analysis. In some examples, system 100 may also perform keyword and term analysis 128 by executing a natural language processing algorithm on audio data (including audio data within videos) of the captured dark web data (or other non-open web data), such as to identify audio containing cryptocurrency addresses or other keywords or terms of interest.

To allow meaningful reputations to be calculated, system 100 may transform concepts, keywords, terms, or other content from web pages into a normalized form that will allow for comparisons. For example, system 100 may associate each web address with a set of labels, representing different categories, based on processing performed on the non-open web data and the open web data, such as processing of raw text or other content.

For example, as part of keyword and term analysis 128, system 100 may extract the text of the top-level page of a web site. System 100 may compare the extracted text, for example, on a word-by-word basis, with keywords that are exemplars of thematic categories, such as “drugs”, “weapons”, “hacking”, “whistleblower”, etc. System 100 may then associate each cryptocurrency address with a set of one or more labels based on the text and/or other content of the web pages on which the cryptocurrency address was found. In some examples, system 100 may perform a normalization based on the prevalence of the keywords in a web data corpus.

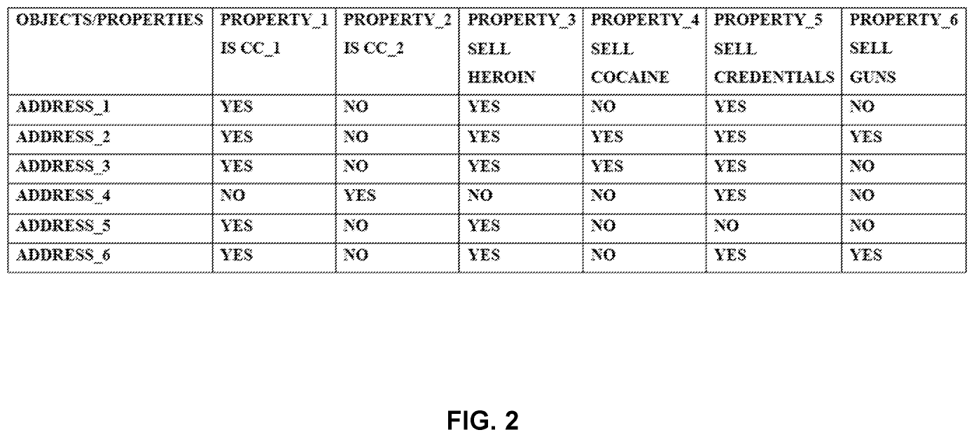

Given an address, system 100, through the above techniques may generate a neighborhood of related addresses and corresponding sets of thematic labels. This may provide sufficient context for many applications. In cases, e.g., where this set is large, system 100 may organize the set hierarchically to allow reputations to be computed based on the more significant aspects. For example, system 100 may use an analysis, such as a FCA, which may facilitate the transformation of the keywords or low-level phrases, such as “selling banned guns” and “selling illegal drugs”, or “selling stolen credentials” to be collected into higher-level concepts, such as “entities selling illegal items.” FCA provides a principled algorithm to analyze collections of objects with properties. When a collection of properties co-occur in a set of objects, the set and their properties together are referred to as a formal concept. FCA produces a concept lattice that can be used to establish relationships between objects, properties, and the concepts implicit in the data. For example, the objects may be cryptocurrency addresses and the properties may be the associated sets of thematic labels. In addition, system 100 using FCA may identify implications between properties, which system 100 may leverage to further structure the relationships between the category labels. An example of a chart of such objects is discussed below with respect to FIG. 2.

System 100 may also download a large corpus of open web data 106 using crawler 112. Crawler 112 may be configured to crawl the open web. For example, crawler 112 may include or utilize a standard web browser to crawl the open web. In some examples, crawler 112 may be a Common Crawl client. Common Crawl is a non-profit that crawls the web four times a year and shares the results publicly via Amazon S3.

The data collected by Common Crawl may be directly used on S3 or downloaded via HyperText Transfer Protocol (HTTP). In some examples, system 100 may utilize open source tools for processing the data collected by Common Crawl. As cryptocurrencies are increasingly used on the open web, many persons post cryptocurrency addresses on web pages as a means for accepting payments or donations. System 100 may collect such data through crawler 112.

As discussed above, the content of web pages on which an address appears provides information which may be useful in computing or determining a reputation ranking. System 100 may parse and extract features and/or keywords 120 of the collected open web data 106 to extract specific data (such as titles, headers, cryptocurrency addresses, text, or the like). This information may be stored and indexed in memory of system 100 (e.g., in database 140). System 100 may automatically extract concepts 130, for example, using an FCA.

System 100 may also perform keyword and term analysis 132. For example, system 100 may perform keyword and term analysis 132 including executing a natural language processing algorithm on audio data (including audio data within videos) of the captured non-open web data, such as to identify audio containing cryptocurrency addresses or other keywords or terms of interest. For example, system 100 may execute a support vector machine. System 100 executing an SVM may cluster extracted keywords and terms into groups, such as those which indicate nefarious purposes and those which do not. The extracted concepts and keyword and term analysis may be stored in database 140 and/or may be used by reputation computation 134 as discussed below.

To perform keyword and term analysis 132, system 100 may, in some examples, use one or more machine learning algorithms, such as a natural language processing algorithm and/or an SVM. System 100 may store the extracted concepts and keywords and term analysis in database 140 and/or may perform reputation computation 134 using the extracted concepts and keywords and/or the term analysis as discussed below. As discussed above with respect to the non-open web data, system 100 may similarly transform concepts, keywords, terms, or other content from web pages into a normalized form that will allow for comparisons. For example, system 100 may associate each web address with a set of labels, representing different categories, based on processing performed on the non-open web data and the open web data, such as processing of raw text or other content.

System 100 may extract the text of the top-level page of a web site. System 100 may compare the extracted text, for example, on a word-by-word basis, with keywords that are exemplars of thematic categories, such as “drugs”, “weapons”, “hacking”, “whistleblower”, etc. System 100 may then associate each cryptocurrency address with a set of one or more labels based on the text and/or other content of the web pages on which the cryptocurrency address was found. In some examples, system 100 may perform a normalization based on the prevalence of the keywords in a web data corpus.

Given an address, system 100, through the above techniques may generate a neighborhood of related addresses and corresponding sets of thematic labels. This may provide sufficient context for many applications. In cases, e.g., where this set is large, system 100 may organize the set hierarchically will allow reputations to be computed based on the more significant aspects. For example, system 100 may use FCA, which may facilitate the transformation of the keywords or low-level phrases, such as “selling banned guns” and “selling illegal drugs”, or “selling stolen credentials” to be collected into higher-level concepts, such as “entities selling illegal items.”

FCA provides a principled method to analyze collections of objects with properties. When a collection of properties co-occur in a set of objects, the set and their properties together are referred to as a formal concept. FCA produces a concept lattice that can be used to establish relationships between objects, properties, and the concepts implicit in the data. For example, the objects may be cryptocurrency addresses and the properties may be the associated sets of thematic labels. In addition, system 100 using FCA may identify implications between properties. System 100 may leverage the identified implications between properties to further structure the relationships between the category labels. An example of a chart of such objects is discussed below with respect to FIG. 2.

System 100 may receive or retrieve (e.g., from database 140) the results of the processing of the blockchain data, the non-open web data, and the open web data and perform reputation computation 134.

In some examples, system 100 may, after the datasets (e.g., blockchain node with full ledger 108, non-open web data 104, and open web data 106) are collected, and after suitable contexts are extracted, refine the information by performing intra-ledger analysis within each cryptocurrency's transactions, and inter-ledger analysis across blockchains from different systems. For example, system 100 may: (i) correlate wallet addresses via causal analysis of transactions, and (ii) cluster wallet addresses based on other meta-data and information (e.g., geolocations, IP-addresses, etc.). System 100 may separately perform each analysis and then combine the results to provide a higher degree of confidence in the inferred relationships between cryptocurrency addresses.

System 100 may perform a reputation computation 134 for each cryptocurrency address. For example, to perform reputation computation 134, system 100 may use the set of features extracted from the cryptocurrency's context, neighborhood, and neighborhood's context, to calculate a baseline reputation. For example, system 100 may determine a reputation measure that combines the output of the analysis performed on the transaction data from blockchains, open web data, and non-open web data.

In some examples, to determine the baseline reputation, system 100 may employ a machine learning algorithm, such as a convolutional neural network, graph long short-term memory (LSTM), graph Transformer, or the like. For example, system 100 may execute a convolutional neural network on the features to determine the baseline reputation. For example, the convolutional neural network may be trained on datasets including a variety of features extracted from the cryptocurrency's context, neighborhood, and neighborhood's context. In some examples, the machine learning algorithm may be supervised. In other examples, the machine learning algorithm may be unsupervised. In the example, where graph-based data is used as input(s) to the machine learning algorithm, such as open web graph data, non-open web graph data, cryptocurrency provenance graph data, intra- and/or inter-ledger graph data, or the like, a graph-based machine learning algorithm may be used, such as a graph LSTM, graph Transformer, or the like.

In some examples, system 100 during reputation computation 134, may refine the baseline reputation by intra- and inter-currency Sybil (fake account) detection—for example, grouping information from different cryptocurrency addresses that have a high correlation within a single ledger or across ledgers—to generate a refined baseline reputation. System 100 may correlate addresses and leverage persona attributes to generate the refined baseline reputation.

To construct a reputation for a pseudonymous user, system 100 may associate the user with as many of the user's cryptocurrency addresses as possible. To affect this, system 100 may use two classes of heuristics. First, system 100 may utilize digital persona attributes to cluster related addresses together—for example, when multiple cryptocurrency addresses are associated with the same forum username. Second, when a user's activity spans multiple cryptocurrencies, the resulting transactions will be spread across multiple different blockchains. System 100 may use inter-ledger analysis to identify apparently independent addresses in different blockchains and associate them with a same user profile.

Leveraging persona attributes is now discussed. System 100 may also perform clustering of cryptocurrency addresses via persona attributes. For example, persona attributes may be attributes that may be associated with a cryptocurrency user (such as an email address, forum user handle, or organization name). System 100 may perform such clustering to establish that there is a relationship between a set of addresses. For example, if an entity uses multiple cryptocurrency addresses to ask for donation on different web sites, system 100 may link them using the corresponding persona attributes.

For example, system 100 may use a Term Frequency Inverse Document Frequency (TF-IDF)-based approach to find and rank persona attributes associated with cryptocurrency addresses. When crawling web pages, system 100 may extract persona attributes from web pages including cryptocurrency addresses. System 100 may then compute the co-occurrence frequencies, tf (a, p), between them, based on the number of times a cryptocurrency address, a, and a persona attribute value, p, are found on the same page. The inverse document frequency weights, idf (p, N)=log (N/K), for the persona attributes, may be computed based on the total number of web pages in the corpus, N, and the number of webpages that contain p, K. Finally, the TF-IDF score between a and p may be computed as tf (a, p)×idf (p, 1V). If two addresses a₁ and a₂ have a high TF-IDF score with the same persona p, system 100 may cluster them together.

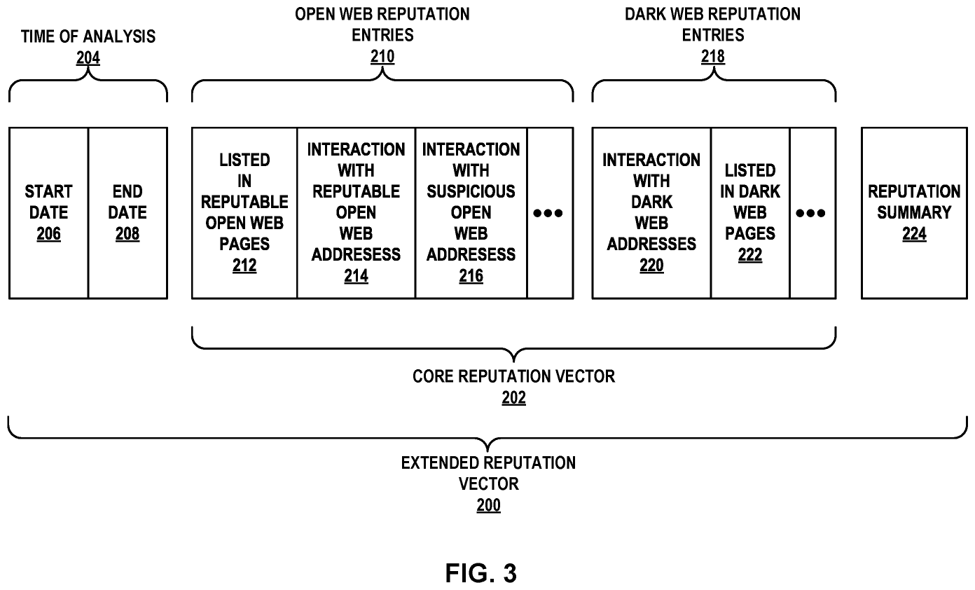

System 100 may use the correlated addresses and persona attributes to generate the refined baseline reputation which, in some examples, may be associated with a plurality of cryptocurrency addresses. The form of the refined baseline reputation or the baseline reputation discussed above is discussed further below with respect to FIG. 3.

FIG. 2 is a chart illustrating an example where objects are cryptocurrency addresses according to one or more aspects of this disclosure. In the example of FIG. 2, the properties assigned to each cryptocurrency address (e.g., during extract concepts 126 and/or extract concepts 130) indicates whether it is a first type of cryptocurrency (Property 1) or a second type of cryptocurrency (Property 2), whether an address was labeled as selling heroin (Property 3), selling cocaine (Property 4), selling stolen credentials (Property 5), and/or selling guns (Property 6). As can be seen, addresses 2, 3, and 6 and properties 1, 3, and 5 represent the concept “first cryptocurrency addresses that are selling heroin and stolen credentials.” It should be understood that these properties are purely set forth as examples and other properties may be used. The properties of the example of FIG. 2 may be used by system 100 when determining a refined baseline reputation or a baseline reputation. As discussed above, the form of the refined baseline reputation or the baseline reputation may take the form of a multi-dimensional data structure, such as a vector, a matrix, a tensor, an ion specification, or the like.

FIG. 3 is a conceptual diagram illustrating an example reputation vector according to one or more aspects of this disclosure. While in the example of FIG. 3, the multi-dimensional data structure is set forth as a vector, in other examples, the multi-dimensional data structure may take other forms, such as a matrix, a tensor, an ion specification, or the like.

Expanded reputation vector 200 may include a core reputation vector 202 and additional data, such as time of analysis 204 and reputation summary 223. Time of analysis may include a start date 206 of the data that was analyzed and an end date 208 of the data that was analyzed. For example, if the data that was analyzed covered the period from Jan. 1, 2022, to Jan. 31, 2022, start date 206 may be Jan. 1, 2022, and end date 208 may be Jan. 31, 2022. In some examples, time of analysis 204 may be more specific and include times associated with the data that was analyzed and not just dates. Reputation summary 223 may include a reputation score or ranking indicative of how risky a given cryptocurrency address may be, a reputation category and/or the like, as is discussed in more detail below.

Core reputation vector 202 may include open web reputation entries 210 and dark web reputation entries 218. Open web reputation entries 210 may include information derived from open web data 106 (FIG. 1). Such data may include whether the cryptocurrency address is listed in reputable open web page(s) 212, interaction with reputable open web addresses 214, interaction with suspicious open web addresses 216, or the like. For example, a reputable open web page may be an open web page that is not directly associated with known illegal activity. For example, a reputable open web address, may be an open web address not directly associated with known illegal activity or an open web address that has a relatively good reputation ranking, such as a reputation ranking determined by the techniques of this disclosure. For example, a suspicious open web address may be an open web address that is directly associated with known and/or suspected illegal activity or an open web address that has a relatively poor reputation ranking, such as a reputation ranking determined by the techniques of this disclosure.

Dark web reputation entries 218 may include information derived from non-open web data 104 (FIG. 1). Such data may include interaction with dark web addresses 220, whether the cryptocurrency address is listed in any dark web pages 222, or the like. While not shown in FIG. 3, additional information such as that discussed above with respect to FIG. 2 may be included in core reputation vector 202.

Table 1 below provides examples of reputation categories, reputation vectors, descriptions and summary/color codes. The illustrative reputation vector column in Table 1 corresponds to the example core reputation vector of FIG. 3, namely the three leftmost elements correspond to those explicitly listed in reputable open web pages 212, interaction(s) with reputable open web addresses 214, and interaction(s) with suspicious open web addresses. The two rightmost elements correspond with interaction(s) with dark web addresses 220 and listed in dark web pages 222.

TABLE 1

| Reputation | Illustrative | | |
|---|---|---|---|
| Category | Reputation Vector | Detailed Description | Summary/Color Code |
| Certified or Openly | [1, 0, 0, 0, 0] | Associated/listed | Trustworthy/Green |
| Reputable or | | with/on reputable | |
| Trustworthy | | open web entries | |
| Reputable or | [0, 1, 0, 0, 0] | Transacting with | Trustworthy/Green |
| Trustworthy by | | other reputable | |
| Association | | addresses | |
| Recently Created | [0, 0, 0, 0, 0] | Address recently | Neutral/Grey |
| | | created | |
| Not Enough Data | [0, 0, 0, 0, 0] | Not enough data to | Neutral/Grey |
| | | assess address in | |
| | | question | |
| Suspicious by | [0, 0, 1, 0, 0] | Currently transacting | Suspicious/Orange |
| Association | | with other suspicious | |
| | | addresses | |
| Historically | [0, 0, 1, 0, 0] | Historically | Suspicious/Orange |
| Suspicious | | associated with | |
| | | suspicious addresses, | |
| | | e.g., a year or more | |
| | | ago | |
| Historically | [0, 0, 0, 1, 0] | Historically | Malicious/Red |
| Malicious or | | associated with | |
| Malicious by | | malicious dark web | |
| Association | | entities, e.g., a | |
| | | year or more ago, | |
| | | or transacting with | |
| | | malicious entities | |
| Openly or Recently | [0, 0, 0, 0, 1] | Associated/listed | Malicious/Red |
| Malicious | | with/on malicious | |
| | | dark web entities | |

While the entries in the summary/color code column of Table 1 may be an examples of reputation summary 224 (based on a core reputation vector as set forth in each row of Table 1) in some examples, other forms of reputation summary 224 may be used.

Association history weighting is now discussed. Assume that w is the cryptocurrency/wallet address being considered, and that OWᵢ and DWⱼ are the vector elements corresponding to analysis criteria from open web data 106 and non-open web data 104, respectively. Let OW₁ denote the normalized number of reputable open web pages in which the address w was found. OW₂ is the normalized number of interactions of w with other reputable open web addresses. Similarly, DW₁ is the normalized number of dark web pages in which the address w was found, while DW₂ is the normalized number of interactions of w with other addresses listed on dark web pages. In some examples, different types of associations may be weighted differently. For example, the origination of a transaction may be weighted differently than the termination of a transaction.

In some examples, system 100 may permit a user to adjust the weights to capture how important each of the criteria is to the user. In some examples, system 100 may present the weights to the user via a user interface as a dial, for example, with values between 0 and 1, where 0 would indicate a criterion is not important while 1 indicates the criterion is very important. To compute reputation summary 224 (FIG. 2), system 100 may start with a weighted sum of the OWᵢ elements. System 100 may subtract a weighted sum of the DWⱼ elements. Further, system 100 may subtract terms representing interactions with suspicious or malicious addresses found on the open web. As a result:

$$RS = {\sum }_{i = 1}^{n - 1} {o}_{i} \times {OW}_{i} - {o}_{s} \times {OW}_{s} - {\sum }_{j = 1}^{m} {d}_{j} \times {DW}_{j} \qquad ( 1 )$$

where RS is reputation summary 224, OWₛ indicates the vector element that represents interactions with suspicious open web addresses 216 (FIG. 2), oₛ is the corresponding weight, n is the number of vector elements extracted from open web data 106 (FIG. 1), and m is the number of vector elements extracted from non-open web data 104 (FIG. 1).

Equation (1) above is one example of how to determine a ranking of reputation summary 224. System 100 may employ other techniques, such as other equations. For example, rather than use a linear formula where weights are multiplied by elements of the vector, then added or subtracted, system 100 may use an equation where the variables are multiplied. In the case of a formula based on multiplication, variables indicating malicious/suspicious activity can be small (closer to 0) while other variables indicating legitimate/trustworthy activity (can be closer to 1). When everything is multiplied, a higher CRS value closer to 1 indicates a good reputation, whereas a (smaller) value closer to 0 indicates malicious/suspicious activity. While, in these examples, a higher number indicates a more trustworthy cryptocurrency address, in other examples, the equation employed by system 100 may be configured such that a higher number indicates a less trustworthy cryptocurrency address. Additionally, or alternatively, the scale of such an output does not need to be between 0 and 1, but may be between any range, for example 0-100.

Bootstrapping is now discussed. Most of the cryptocurrency addresses will not be listed either on open web pages or non-open web pages. So, system 100 may assign reputations largely based on transactional data. This may require an initial set of addresses that have been assigned reputations.

For example, system 100 may assign reputations to the addresses listed on open web pages or non-open web pages. (These are depicted in the top and bottom rows in Table 1.) System 100 may then determine reputations for the addresses that transact with these addresses. System 100 may determine reputations for addresses that transact with addresses that transact with the addresses listed on open web pages or non-open web pages. System 100 may continue this process recursively to propagate reputation labels. In this manner, system 100 may be able to determine a reputation for cryptocurrency addresses in each category set forth in Table 1, even if a given cryptocurrency address is not found in non-open web data 104 or open web data 106.

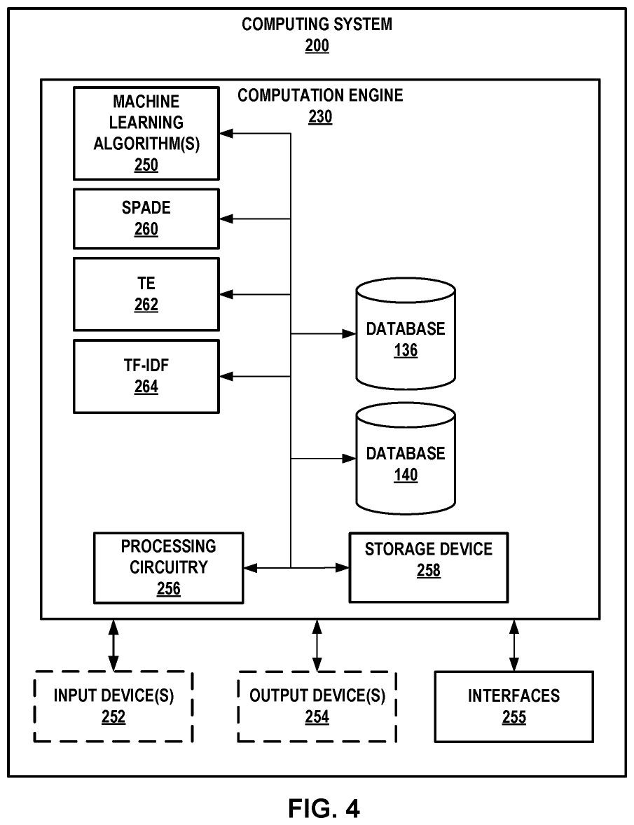

FIG. 4 is a block diagram illustrating example system for ranking cryptocurrencies according to one or more aspects of this disclosure. System 200 may be an example of system 100. System 200 includes computation engine 230 and interfaces 255. Interfaces 255 may include API 142, web interface 144, BPI 146, application 148 of FIG. 1, and/or one or more network interfaces for interconnecting system 200 with another cryptocurrency system or service, for accessing blockchain data, for crawling the non-open web, and/or for crawling the open web. For example, interfaces 255 may facilitate a user, not located at the location of system 200, to query system 200 for a reputation summary, such as reputation summary 224, a core reputation vector, such as core reputation vector 202, and/or an extended reputation vector, such as extended reputation vector 200, and to receive such back from system 200. Interfaces 255 may also facilitate system 200 acquiring blockchain data, non-open web data, and open web data.

In some examples, system 200 may include one or more input device(s) 252, such as for manually inputting data into system 200, and/or one or more output device(s) 254, such as for displaying or otherwise presenting data to a user of system 200. In some examples, while not shown, input device(s) 252 and/or output device(s) 254 may access system 200 via interfaces 255. In some examples, computing system 200 is a single computing device, such as a server. In some examples, computing system 200 is distributed across a plurality of computing devices and interconnected by a computer network (e.g., a cloud-based system).

A user of computing system 200 may provide input to computing system 200 via one or more input device(s) 252, which may include a keyboard, a mouse, a microphone, a touch screen, a touch pad, or another input device that is coupled to computing system 120 via one or more hardware user interfaces. Input device(s) 252 may include hardware and/or software for establishing a connection with computation engine 230. In some examples, input device(s) 252 may communicate with computation engine 230 via a direct, wired connection, over a network, such as the Internet, or any public or private communications network, for instance, broadband, cellular, Wi-Fi, and/or other types of communication networks, capable of transmitting data between computing systems, servers, and computing devices. Input devices 252 may be configured to transmit and receive data, control signals, commands, and/or other information across such a connection using any suitable communication techniques to receive the sensor data. In some examples, input devices 252 and computation engine 230 may each be operatively coupled to the same network using one or more network links. The links coupling input devices 252 and computation engine 230 may be wireless wide area network link, wireless local area network link, Ethernet, Asynchronous Transfer Mode (ATM), or other types of network connections, and such connections may be wireless and/or wired connections.

Output device(s) 254 may include a display, sound card, video graphics adapter card, speaker, presence-sensitive screen, one or more USB interfaces, video and/or audio output interfaces, or any other type of device capable of generating tactile, audio, video, or other output. Output device(s) 254 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In other examples, output device(s) 254 may produce an output to a user in another fashion, such as via a sound card, video graphics adapter card, speaker, presence-sensitive screen, one or more USB interfaces, video and/or audio output interfaces, or any other type of device capable of generating tactile, audio, video, or other output. In some examples, output device(s) 254 may include a presence-sensitive display that may serve as a user interface device that operates both as one or more input devices and one or more output devices. In some examples, output device(s) 254 comprise one or more interfaces for transmitting data to another computing device over a wired or wireless connection.

Computation engine 230 includes database 136, database 140, machine learning algorithm(s) 250, SPADE 252, TE 254, processing circuitry 256, and storage device 258. Computation engine 230 may represent software executable by processing circuitry 256 and stored on storage device 258, or a combination of hardware and software. Such processing circuitry 256 may include any one or more of a microprocessor, a controller, a digital signal processor (DSP), an application specific integrated circuit (ASIC), a field-programmable gate array (FPGA), or equivalent discrete or integrated logic circuitry. Storage device 258 may include memory, such as random-access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. In some examples, one or both of database 136 and database 140 may be part of storage device 258.

Machine learning algorithm(s) 250 may include a support vector machine (SVM). Processing circuitry 256 may execute an SVM to perform keyword and term analysis 128 and/or to perform keyword and term analysis 132. SVM is learning model/algorithm that analyzes data for classification and/or regression analysis. SVM may be supervised or unsupervised. For example, SVM may cluster keywords and terms into groups, such as reputable and non-reputable. SVM may be trained on various keywords and terms to distinguish those that may be reputable and those that may not, e.g., drugs, guns, etc.

Machine learning algorithm(s) 250 may include an FCA algorithm. Processing circuitry 256 may execute an FCA to facilitate the transformation of the keywords or low-level phrases, such as “selling banned guns” and “selling illegal drugs”, or “selling stolen credentials” to be collected into higher-level concepts, such as “entities selling illegal items.” FCA may be an unsupervised machine learning technique which may be trained on data sets so as to cluster keywords and lower level phrases into higher order concepts. For example, FCA may provide a principled method to analyze collections of objects with properties. When a collection of properties co-occur in a set of objects, the set and their properties together are referred to as a formal concept.

Machine learning algorithm(s) 250 may include a natural language processing algorithm. Processing circuitry 256 may execute a natural language processing algorithm when, for example, performing term analysis 128 and/or performing keyword and term analysis 132 on audio data (including audio data of video data) of non-open web data 104 and/or open web data 106, such as to identify any cryptocurrency addresses which may be present in the audio data. The natural language processing algorithm may be trained on audio data containing cryptocurrency addresses so as to be able to identify audio data including a cryptocurrency address. In some examples, the natural language processing algorithm may further be trained to recognize other terms that may appear in audio data, such as those indicating a potentially nefarious use of a cryptocurrency address (e.g., selling guns, drugs, etc.).

Machine learning algorithm(s) 250 may include a convolution neural network, a graph LSTM, a graph Transformer, or the like, which processing circuitry 256 may execute, in some examples, to determine a baseline reputation. System 100 may execute the convolutional neural network on extracted features from the collected data to determine the baseline reputation. For example, the convolutional neural network may be trained on datasets including a variety of features extracted from the cryptocurrency's context, neighborhood, and neighborhood's context.

Processing circuitry 256 may execute SPADE 260 to perform provenance analysis 114 (FIG. 1). For example, processing circuitry 256 may execute SPADE 260 to discover all available paths (even through multiple intermediate transactions) between a payer and payee. and conduct an ancestral lineage query which may return all payers whose cryptocurrency goes to a specific transaction or payee. Processing circuitry 256 may also execute SPADE 260 to conduct a query for descendants which may determine all payees who received all or part of a payment. Processing circuitry 256 may inspect an agent vertex (associated with a cryptocurrency address) which may allow all the incoming and outgoing payments to be directly identified.

Processing circuitry 256 may execute TE 262 to perform causality analysis 122 and/or to cluster related addresses together using intra- and inter-ledger time series analysis. Processing circuitry 256 may execute TF-IDF 264 to leverage persona data when clustering related addresses together.

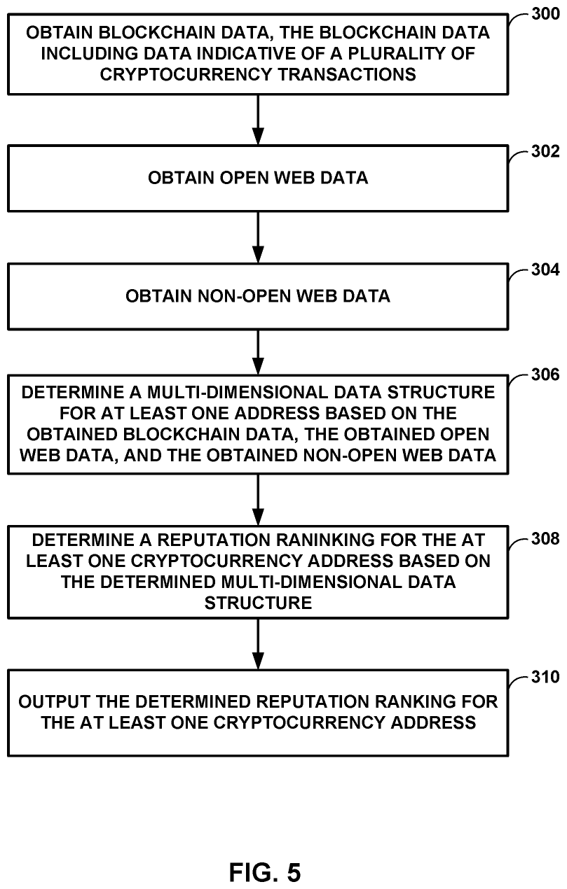

FIG. 5 is a flow diagram illustrating example cryptocurrency address ranking techniques according to one or more aspects of this disclosure. While described with respect to device 200 of FIG. 4, the techniques of FIG. 5 may be performed by any device capable of performing such techniques.

Processing circuitry 256 may obtain blockchain data, the blockchain data including data indicative of a plurality of cryptocurrency transactions (300). For example, processing circuitry 256 may download a blockchain node with a full ledger 108 from blockchain data 102. Processing circuitry 256 may obtain open web data (302). For example, processing circuitry 256 may employ crawler 112 to download at least a portion of open web data 106. Processing circuitry 256 may obtain non-open web data (304). For example, processing circuitry 256 may employ crawler 110 to download at least a portion of non-open web data 104 (which may include dark web data and/or private data).

Processing circuitry 256 may determine a multi-dimensional data structure for the at least one cryptocurrency address based on the obtained blockchain data, the obtained open web data, and the obtained non-open web data (306). For example, the multi-dimensional data structure may include a vector. The non-open web data may include at least one of dark web data or private data. For example, processing circuitry 256 may determine core reputation vector 202, or other multi-dimensional data structure indicative of a reputation for the at least one cryptocurrency address. For example, the multi-dimensional data structure (e.g., core reputation vector 202) may include one or more indications of (i) whether the at least one cryptocurrency address is listed in at least one reputable open web page, (ii) whether the at least one cryptocurrency address has at least one interaction with an open web address, (iii) whether the at least one cryptocurrency address has at least one interaction with a suspicious open web address, (iv) whether the at least one cryptocurrency address has interacted with at least one dark web address, or (v) whether the at least one cryptocurrency address is listed in at least one dark web address.

Processing circuitry 256 may determine a reputation ranking for the at least one cryptocurrency address based on the determined multi-dimensional data structure (308). For example, processing circuitry 256 may calculate a reputation ranking based on core reputation vector 202 and may include the reputation ranking in reputation summary 224 of extended reputation vector 200. Processing circuitry 200 may output the determined reputation ranking for the at least one cryptocurrency address (310). For example, processing circuitry may output extended reputation vector 200 via any of interfaces 255 for viewing or consumption by a user. For example, interfaces 255 may include a plurality of interfaces, the plurality of interfaces including at least two of web site interface 144, smartphone application interface 148, web browser plug-in interface 146, or a web-based application programming interface 142.

In some examples, prior to determining the multi-dimensional data structure for the at least one cryptocurrency address, processing circuitry 256 may determine a neighborhood associated with the at least one cryptocurrency address, the neighborhood including at least one of first cryptocurrency addresses transactionally associated which the at least one cryptocurrency address or second cryptocurrency addresses transactionally associated with the at least one of the first cryptocurrency addresses. In some examples, as part of determining the neighborhood, processing circuitry 256 may extract open web persona data from the open web data, the open web persona data including attributes associated with a cryptocurrency user. In some examples, as part of determining the neighborhood, processing circuitry 256 may extract non-open web persona data from the non-open web data, the non-open web persona data including attributes associated with the cryptocurrency user. In some examples, processing circuitry 256 may determine whether there is a correlation between any of a plurality of addresses and the at least one cryptocurrency address based on the open web persona data and the non-open web persona data, wherein the neighborhood includes any correlated addresses of the plurality of addresses to the at least one cryptocurrency address.

In some examples, as part of determining the neighborhood, processing circuitry 256 may perform a provenance analysis on the data indicative of the plurality of cryptocurrency transactions. In some examples, processing circuitry 256 may abstract, from the data indicative of the plurality of cryptocurrency transactions, at least one of (i) an address originating a cryptocurrency transaction with the at least one cryptocurrency address, (ii) an address terminating the cryptocurrency transaction with the at least one cryptocurrency address, or (iii) connectivity between two or more addresses involved in the cryptocurrency transaction, wherein the at least one of the first cryptocurrency addresses include the at least one of (i) the address originating the cryptocurrency transaction with the at least one cryptocurrency address, (ii) the address terminating the cryptocurrency transaction with the at least one cryptocurrency address, or (iii) the two or more addresses involved in the cryptocurrency transaction.

In some examples, processing circuitry 256 may perform a causality analysis on the data indicative of the plurality of cryptocurrency transactions to verify the plurality of cryptocurrency transactions.

In some examples, as part of determining the neighborhood associated with the at least one cryptocurrency address, processing circuitry 256 may execute a machine learning algorithm.

In some examples, prior to determining the multi-dimensional data structure for the at least one cryptocurrency address, processing circuitry 256 may extract at least one of keywords or features from the open web data and extract at least one of the keywords or the features from the non-open web data. In some examples, processing circuitry 256 may, prior to determining the multi-dimensional data structure for the at least one cryptocurrency address, perform an analysis (e.g., an FCA) on a plurality of addresses and at least one of the extracted at least one of keywords or features from the open web data or the extracted at least one of keywords or features from the non-open web data. In some examples, based on the analysis, processing circuitry 256 may determine at least one respective label for one or more of the plurality of addresses. In some examples, as part of determining the reputation ranking for the at least one cryptocurrency address, processing circuitry 256 may apply a user configurable weighted formula to the multi-dimensional data structure.

In some examples, the at least one cryptocurrency address is at least one cryptocurrency address of a plurality of cryptocurrency addresses for a first cryptocurrency, and processing circuitry 256 may determine a respective multi-dimensional data structure for each cryptocurrency address of the plurality of cryptocurrency addresses for the first cryptocurrency based on the obtained blockchain data, the obtained open web data, and the obtained non-open web data. Processing circuitry 256 may determine a respective reputation ranking for each respective cryptocurrency address based on the determined respective multi-dimensional data structure. Processing circuitry 256 may determine an overall reputation ranking for the first cryptocurrency based on the determined respective reputation rankings. Processing circuitry 256 may output the determined overall reputation ranking for the first cryptocurrency.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A cryptocurrency ranking system comprising:
a memory configured to store at least one cryptocurrency address; and
one or more processors coupled to the memory, the one or more processors being configured to:
obtain blockchain data, the blockchain data comprising data indicative of a plurality of cryptocurrency transactions;
obtain open web data;
obtain non-open web data;
determine a multi-dimensional data structure for the at least one cryptocurrency address based on the obtained blockchain data, the obtained open web data, and the obtained non-open web data;
determine a reputation ranking for the at least one cryptocurrency address based on the determined multi-dimensional data structure; and
output the determined reputation ranking for the at least one cryptocurrency address.

2. The cryptocurrency ranking system of claim 1, wherein the one or more processors are further configured to, prior to determining the multi-dimensional data structure for the at least one cryptocurrency address, determine a neighborhood associated with the at least one cryptocurrency address, the neighborhood comprising at least one of first cryptocurrency addresses transactionally associated which the at least one cryptocurrency address or second cryptocurrency addresses transactionally associated with the at least one of the first cryptocurrency addresses.

3. The cryptocurrency ranking system of claim 2 wherein as part of determining the neighborhood, the one or more processors are further configured to:
extract open web persona data from the open web data, the open web persona data including attributes associated with a cryptocurrency user;
extract non-open web persona data from the non-open web data, the non-open web persona data including attributes associated with the cryptocurrency user;
determine whether there is a correlation between any of a plurality of addresses and the at least one cryptocurrency address based on the open web persona data and the non-open web persona data, wherein the neighborhood comprises any correlated addresses of the plurality of addresses to the at least one cryptocurrency address.

4. The cryptocurrency ranking system of claim 2, wherein as part of determining the neighborhood, the one or more processors are configured to:
perform a provenance analysis on the data indicative of the plurality of cryptocurrency transactions; and
abstract, from the data indicative of the plurality of cryptocurrency transactions, at least one of (i) an address originating a cryptocurrency transaction with the at least one cryptocurrency address, (ii) an address terminating the cryptocurrency transaction with the at least one cryptocurrency address, or (iii) connectivity between two or more addresses involved in the cryptocurrency transaction, wherein the at least one of the first cryptocurrency addresses comprise the at least one of (i) the address originating the cryptocurrency transaction with the at least one cryptocurrency address, (ii) the address terminating the cryptocurrency transaction with the at least one cryptocurrency address, or (iii) the two or more addresses involved in the cryptocurrency transaction.

5. The cryptocurrency ranking system of claim 4, wherein the one or more processors are further configured to perform a causality analysis on the data indicative of the plurality cryptocurrency of transactions to verify the plurality of cryptocurrency transactions.

6. The cryptocurrency ranking system of claim 2, wherein as part of determining the neighborhood associated with the at least one cryptocurrency address, the one or more processors are configured to execute a machine learning algorithm.

7. The cryptocurrency ranking system of claim 1, wherein the one or more processors are further configured to, prior to determining the multi-dimensional data structure for the at least one cryptocurrency address:
extract at least one of keywords or features from the open web data; and
extract at least one of the keywords or the features from the non-open web data.

8. The cryptocurrency ranking system of claim 7, wherein the one or more processors are further configured to, prior to determining the multi-dimensional data structure for the at least one cryptocurrency address:
perform an analysis on a plurality of addresses and at least one of the extracted at least one of keywords or features from the open web data or the extracted at least one of keywords or features from the non-open web data; and
based on the analysis, determine at least one respective label for one or more of the plurality of addresses.

9. The cryptocurrency ranking system of claim 1, wherein the non-open web data comprises at least one of dark web data or private data.

10. The cryptocurrency ranking system of claim 9, wherein the multi-dimensional data structure comprises one or more indications of (i) whether the at least one cryptocurrency address is listed in at least one reputable open web page, (ii) whether the at least one cryptocurrency address has at least one interaction with an open web address, (iii) whether the at least one cryptocurrency address has at least one interaction with a suspicious open web address, (iv) whether the at least one cryptocurrency address has interacted with at least one dark web address, or (v) whether the at least one cryptocurrency address is listed in at least one dark web address.

11. The cryptocurrency ranking system of claim 1, wherein as part of determining the reputation ranking for the at least one cryptocurrency address, the one or more processors are configured to apply a user configurable weighted formula to the multi-dimensional data structure.

12. The cryptocurrency ranking system of claim 1, further comprising a plurality of interfaces, the plurality of interfaces comprising at least two of a web site interface, a smartphone application interface, a web browser plug-in interface, or a web-based application programming interface.

13. The cryptocurrency ranking system of claim 1, wherein the at least one cryptocurrency address is at least one cryptocurrency address of a plurality of cryptocurrency addresses for a first cryptocurrency, and wherein the one or more processors are further configured to:
determine a respective multi-dimensional data structure for each cryptocurrency address of the plurality of cryptocurrency addresses for the first cryptocurrency based on the obtained blockchain data, the obtained open web data, and the obtained non-open web data;
determine a respective reputation ranking for each respective cryptocurrency address based on the determined respective multi-dimensional data structure;
determine an overall reputation ranking for the first cryptocurrency based on the determined respective reputation rankings; and
output the determined overall reputation ranking for the first cryptocurrency.

14. The cryptocurrency ranking system of claim 1, wherein the multi-dimensional data structure comprises a vector.

15. A method of ranking cryptocurrency comprising:
obtaining blockchain data, the blockchain data comprising data indicative of a plurality of cryptocurrency transactions;
obtaining open web data;
obtaining non-open web data;
determining a multi-dimensional data structure for at least one cryptocurrency address based on the obtained blockchain data, the obtained open web data, and the obtained non-open web data;
determining a reputation ranking for the at least one cryptocurrency address based on the determined multi-dimensional data structure; and
outputting the determined reputation ranking for the at least one cryptocurrency address.

16. The method of claim 15, further comprising, prior to determining the multi-dimensional data structure for the at least one cryptocurrency address, determining a neighborhood associated with the at least one cryptocurrency address, the neighborhood comprising at least one of first cryptocurrency addresses transactionally associated which the at least one cryptocurrency address or second cryptocurrency addresses transactionally associated with the at least one of the first cryptocurrency addresses.

17. The method of claim 16, wherein determining the neighborhood comprises:
extracting open web persona data from the open web data, the open web persona data including attributes associated with a cryptocurrency user;
extracting non-open web persona data from the non-open web data, the non-open web persona data including attributes associated with the cryptocurrency user;
determining whether there is a correlation between any of a plurality of addresses and the at least one cryptocurrency address based on the open web persona data and the non-open web persona data, wherein the neighborhood comprises any correlated addresses of the plurality of addresses to the at least one cryptocurrency address.

18. The method of claim 16, wherein determining the neighborhood comprises:
performing a provenance analysis on the data indicative of the plurality of cryptocurrency transactions; and
abstracting, from the data indicative of the plurality of cryptocurrency transactions, at least one of (i) an address originating a cryptocurrency transaction with the at least one cryptocurrency address, (ii) an address terminating the cryptocurrency transaction with the at least one cryptocurrency address, or (iii) connectivity between two or more addresses involved in the cryptocurrency transaction, wherein the at least one of the first cryptocurrency addresses comprise the at least one of (i) the address originating the cryptocurrency transaction with the at least one cryptocurrency address, (ii) the address terminating the cryptocurrency transaction with the at least one cryptocurrency address, or (iii) the two or more addresses involved in the cryptocurrency transaction.

19. The method of claim 18, further comprising performing a causality analysis on the data indicative of the plurality of cryptocurrency transactions to verify the plurality of cryptocurrency transactions.

20. A non-transitory computer-readable storage medium storing instructions that, when executed by one or more processors, cause the one or more processors to:
obtain blockchain data, the blockchain data comprising data indicative of a plurality of cryptocurrency transactions;
obtain open web data;
obtain non-open web data;
determine a multi-dimensional data structure for at least one cryptocurrency address based on the obtained blockchain data, the obtained open web data, and the obtained non-open web data;
determine a reputation ranking for the at least one cryptocurrency address based on the determined multi-dimensional data structure; and
output the determined reputation ranking for the at least one cryptocurrency address.
